(19) United States
(12) Patent Application Publication
(10) Pub. No.: US 2020/0242606 A1
(43) Pub. Date: Jul. 30, 2020

(54) SYSTEM AND METHOD FOR IMPROVING ACCESS TO FINANCIAL SERVICES FOR CHILDREN

(71) Applicant: Richard Ernest Logan, Wichita, KS (US)

(72) Inventor: Richard Ernest Logan, Wichita, KS (US)

(21) Appl. No.: 16/501,545

(22) Filed: Apr. 29, 2019

Related U.S. Application Data
(60) Provisional application No. 62/918,430, filed on Jan. 29, 2019.

(51) Int. Cl. G06Q 20/40

(52) U.S. Cl. CPC G06Q 20/405

(57) ABSTRACT

A tool and a method are provided for allowing a person to access financial services from a financial institution which has a financial institution data processing system including at least one computer containing stored financial service data pertaining to financial services for a child. The financial service data includes data relating to at least one chore assigned to the child by his or her parent. The child has a computer for communicating with the financial institution data processing system. The parent also has a computer for communicating with the financial institution data process system to monitor the transactions of the child along with the pending financial services available to the child. A non-transitory computer-readable medium is also provided. The medium comprises encoded instructions for execution by the one or more processors of a computer. The instructions when executed are operable to receive a set of data from a financial institution. The data pertains to the chore assigned to the child by the parent. The instructions when also executed are operable to determine if the assigned chore has been completed by the child. Also further provided is a system which contains a financial institution network comprising a data processing system including at least one computer having stored financial service data pertaining to financial services for a child. The system further comprises a cloud services network and computer(s) for the child and parent.

### CROSS-REFERENCE TO RELATED APPLICATION

This is a non-provisional, utility patent application related to Provisional patent application having application No. 62/918,430, filed Jan. 29, 2019, inventor Richard H. Logan, entitled “A System and Method for Improving Access to Financial Benefits for Children.” Provisional patent application having application No. 62/918,430, filed Jan. 29, 2019, is fully incorporated herein by reference thereto as if repeated verbatim immediately herein. All benefits of the Jan. 29, 2019 filing date for the Provisional Patent application is claimed.

### BACKGROUND OF THE INVENTION

### 1. Field of the Invention

Embodiments of the present invention provide a tool. More specifically, embodiments of the present invention provide a literacy tool which generally comprises a system and method for improving access to financial services for children.

### 2. Description of the Background Art

Today, it is important that children learn the skills necessary to make sound financial decisions. Otherwise, children will go through life with the inability to decide what is financially best for them, possibly leading to bad credit as well as bankruptcy. Thus, what is needed and what has been invented is a financial literacy tool that allows parents to start training children early as to how to control spending and make prudent decisions as to financial spending. The literacy tool of the present invention allows parents to give their children access to money, such as through a debit card or a loan, while simultaneously monitoring and controlling their children's spending.

### SUMMARY OF EMBODIMENTS OF THE INVENTION

Embodiments of the present invention provide a tool for allowing a person to access financial services from a financial institution. The tool comprises a financial institution data processing system having at least one computer which includes stored financial service data pertaining to financial services for a person (preferably a child or a person younger than the age of majority, such as 18). The financial service data is selected from the group of data comprising data relating to at least one chore assigned to the first person by a second person, and data relating to a dollar amount of the assigned chore. The tool also includes a first computer with a display screen for the person. The first computer is adapted for communicating with the financial institution data processing system. The tool further also includes a second computer for another person, such as a parent of the person who possesses the first computer. The second computer has a display screen and is adapted by its user for communicating with the financial institution data process system to monitor the financial services.

Embodiments of the present invention also provide a method for accessing financial services from a financial institution. The method comprises assigning at least one chore, and dollar value for chore, to a child; and storing the assigned chore and the dollar value in a financial institution data processing system. The child uses a computer to access the financial institution data processing system for indicating that the chore has been completed.

Embodiments of the present invention also further provide a system for allowing a person to access financial services from a financial institution. The system includes a financial institution network which has a data processing system that has at least one computer with stored financial service data pertaining to financial services for a first person. The financial service data includes data relating to at least one chore assigned to a child by a parent. The system includes a cloud services network and a computer (e.g., an IOS device) which is to be used by the child for communicating with the financial institution data processing system through the cloud services network. The child computer has a display screen for displaying information. The system also includes a computer (e.g., an android device) which is to be used by a parent of the child for communicating with the financial institution data process system through the cloud services network to monitor the financial services. The parent computer has a display screen for displaying information related to the child and the financial services.

In a preferred embodiment of the invention the cloud services network comprises an application server for communicating with the computers, and a notification hub communicating with the application server for allowing the user of the computers to transmit notifications. An application API is included for specifying how the software components of the system operate. The cloud services network further comprises a database server communicating with the application API, and an administrator site web server communicating with the application API.

Embodiments of the present invention also further provide a non-transitory computer-readable medium comprising encoded instructions for execution by one or more processors of a computer. When the instructions are executed, they are operable to receive data from a financial institution. The data pertains to at least one chore assigned to a first person by a second person. The instructions when executed also determine, based on the received data, if the assigned chore has been completed by the first person.

Practice of embodiments of the present invention allows children to use financial services to obtain money into their account while also allowing them to transfer money out of their account. Children may receive money into the account by: (1) chore completion; (2) an allowance setup; (3) loan request; and (4) money request.

In order for a child to receive money by completing a chore, a parent initially assigns one or more chores to a child, along with a dollar amount for each chore. When a child marks an assigned task or chore (i.e., a piece of work to be done or undertaken or a job or duty) as completed, the parent then decides whether to approve or not approve the completed chore or task(s). If the parent approves the task(s), money is transferred from the parent's account to the child's account. The parent may setup an allowance for a child, which is a quick and easy way for the child to determine when he or she will be paid and how much. The parent may also deposit money into a financial institution for the benefit of the child who may receive the money by a loan request or a request for money.

Practice of embodiments of the present invention also facilitates the placing of several unique controls which allow for funds to be withdrawn from an account at the financial institution. Financial institutions often want to give debit cards to people under the age of 18; however there is significant risk in providing a debit card to an individual under the age of 18. Practice of embodiments of the present invention mitigates that risk by setting daily spending limits based on a child's age. The limits are determined by the financial institution. For example, a younger child might only be allowed between 10 and 70 dollars spending per day. A teenager might be allowed up to $600 per day. By setting these control on a child's debit card encourages financial institution to provide debit cards to youth and teens. Another risk with giving debit cards to teens and children is that they might lose the card without knowing it. Practice of embodiments of the present invention provides for the parent to receive push notifications every time a child performs a transaction on their debit card. In turn, if the parent sees something that is out of the ordinary, the parent can quickly take action to prevent losses for the financial institution and his/her child.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only and not by way of any limitation, wherein:

### BRIEF DESCRIPTION OF THE DRAWINGS

FIG. 1 is a high level network diagram of the hardware and network design for the literacy tool of the present invention.

FIG. 2 is a diagram of a pair of end user computer devices (e.g. an IOS device having an Apple mobile operating system; and an Android device having an operating system developed by Google), which are part of the hardware for the literacy tool of the present invention.

FIG. 3 is a diagram for cloud-service hardware which is made available for the end user computer devices on demand via the Internet.

FIG. 4 is a diagram of hardware for a financial institution network which is part of the hardware for the literacy tool of the present invention.

FIG. 5 is a functional flow block diagram of logging into a computer system for commencing an embodiment of the present invention.

FIG. 6 is a block flow diagram of an embodiment of the present invention for a child carousel select page.

FIG. 7 is a block flow diagram of an embodiment of the present invention for a parent login.

FIG. 8 is a block flow diagram of an embodiment of the present invention for a parent menu.

FIG. 9 is a block flow diagram of an embodiment of the present invention for a children menu.

FIG. 10 is a block flow diagram of an embodiment of the present invention for a management tasks menu.

FIG. 11 is a block flow diagram of an embodiment of the present invention for a management account menu.

FIG. 12 is a block flow diagram of an embodiment of the present invention for where money is requested.

FIG. 13 is a block flow diagram of an embodiment of the present invention for where a loan is requested.

FIG. 14 is a block flow diagram of an embodiment of the present invention for determining if one (or more tasks) has been completed.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification may contain material which is subject to copyright protection. Computer program source code, object code, instructions, text or other functional information that is executable by a machine may be included in an appendix, tables, Figures or in other forms. The copyright owner has no objection to the facsimile reproduction of the specification as filed in the Patent and Trademark Office. Otherwise all copyright rights are reserved.

A “computer” for purposes of embodiments of the present invention may be any device having a processor. By way of example only, a “computer” may be a mainframe computer, a personal computer, a laptop, a notebook, a microcomputer, a server, or any of the like. By further way of example only, a “computer” is merely representative of many diverse products, such as by way of example only: pagers, cellular phones, smart phones, androids, handheld personal information devices, stereos, VCRs, set-top boxes, calculators, appliances, dedicated machines (e.g., ATMs, kiosks, ticket booths, and vending machines, etc.), and any other type of computer-based product, and so forth. A “server” may be any suitable server (e.g., database server, disk server, file server, network server, terminal server, etc.), including a device or computer system that is dedicated to providing specific facilities to other devices attached to a network. A “server” may also be any processor-containing device or apparatus, such as a device or apparatus containing CPUs.

A “processor” includes a system or mechanism that interprets and executes instructions (e.g., operating system code) and manages system resources. More particularly, a “processor” may accept a program as input, prepares it for execution, and executes the process so defined with data to produce results. A processor may include an interpreter, a compiler and run-time system, or other mechanism, together with an associated host computing machine and operating system, or other mechanism for achieving the same effect. A “processor” may also include a central processing unit (CPU) which is a unit of a computing system which fetches, decodes and executes programmed instruction and maintains the status of results as the program is executed. A CPU is the unit of a computing system that includes the circuits controlling the interpretation of instruction and their execution.

A “computer program” may be any suitable program or sequence of coded instructions which are to be inserted into a computer, well known to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images. It is known that computer data is information processed or stored by a computer. The information may be in the form of software programs, as well as images, test documents and audio clips.

A “computer-readable medium” for purposes of embodiments of the present invention may be any medium (preferably a non-transitory medium) that can contain, store, communicate, propagate, or transport a program (e.g., a computer program) for use by or in connection with the instruction execution system, apparatus, system or device. The computer-readable medium can be, by way of example only but not by limitation, an electronic, magnetic, optical, electromagnetic, infrared, or semiconductor system, apparatus, system, device, propagation medium, or computer memory.

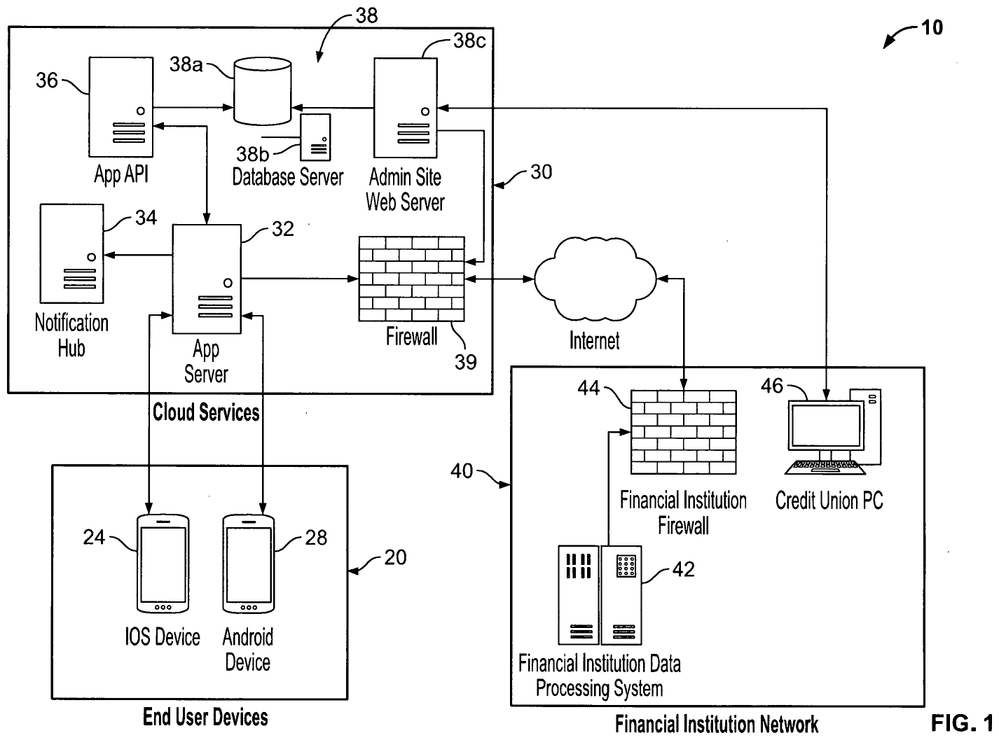

Referring in detail now to the drawings, wherein similar components or devices are represented by like reference numerals, there is seen in FIG. 1 a diagram of a high level network, generally illustrated as 10, of the hardware and network design for the literacy tool of the present invention. The high level network 10 includes end user computer devices, generally illustrated as 20; cloud-service hardware, generally illustrated as 30; and a financial institution network, generally illustrated as 40.

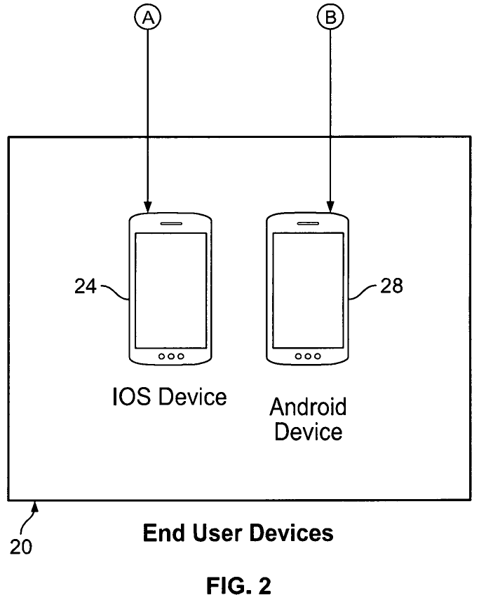

The end user computer devices 20 may be any computer devices (e.g. mobile, desk top computers, etc.) capable of functioning for purposes of the literacy tool of the present invention. As best shown in FIG. 2, in a preferred embodiment of the present invention, the end user computer devices 20 comprise an IOS device 24 having an Apple mobile operating system, and an Android device 28 having an operating system developed by Google, all of which are part of the hardware for the literacy tool of the present invention.

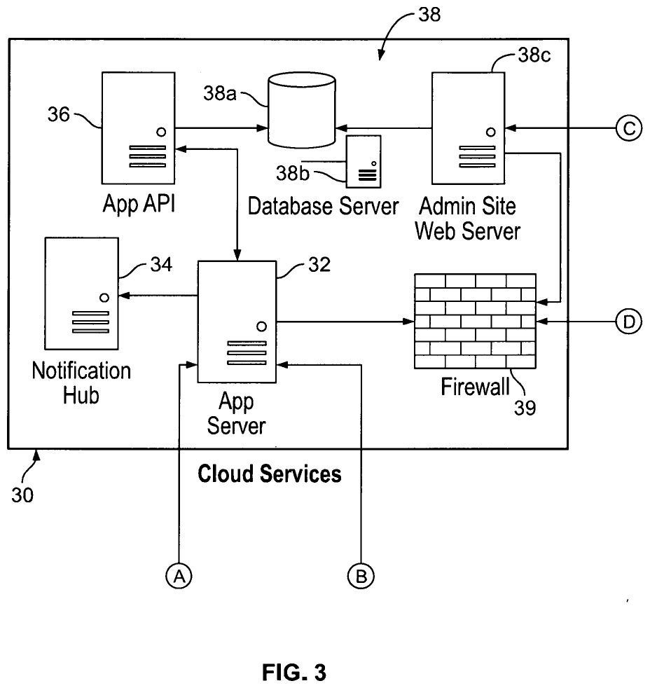

The cloud-service hardware 30 comprise the necessary components to enable the end user devices 20 to make operable connections and communications via the Internet with the financial institution network 40. Cloud-service hardware 30 typically ranges from development platforms and complete applications to computer servers, storage devices and virtual desktops. In a preferred embodiment of the present invention, as best shown in FIGS. 1 and 3, the cloud computing hardware 30 (e.g. Microsoft Azure) includes an App server 32 (which communicates with end user devices 20), a notification hub 34 (e.g. an Azure notification hub which allows an end user to transmit any notification(s) to any desired platform (iOS, Android, Windows, etc.), an App API 36 (which specifies how the software components for the literacy tool operate), servers 38 (i.e., database servers 38a, 38b, and admin site web server 38c), and firewall 39 (which blocks unauthorized access from Internet while allowing permitted data packets to enter or leave the cloud services furnished by cloud-service hardware 30). In a preferred embodiment of the invention, App API may be an interactive array-oriented language and integrated development environment which may be purchased from any commercial vendor for the computer platform.

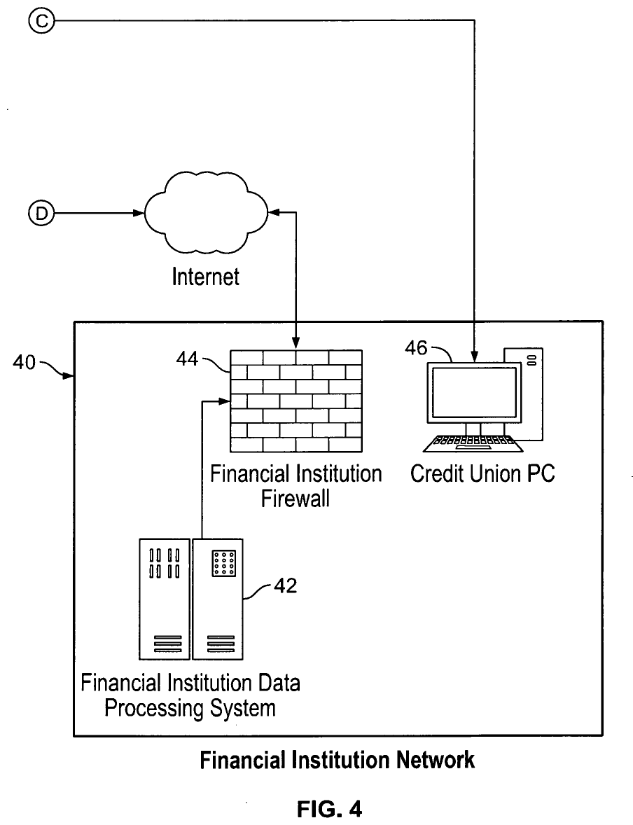

The financial institution network 40 comprises appropriate data processing systems, servers and computer. In a preferred embodiment of the present invention, as best shown in FIGS. 1 and 4, the financial institution network 40 comprises data processing system 42, firewall 44 and one or more computers such as PCs 46. A financial institution is an enterprise, such as a bank, authorized by the government to accept deposits, collect money, disburse money, transfer money from one account to another, pay interest, clear checks, make loans, act as an intermediary in financial transactions, and provide other financial services to its customers.

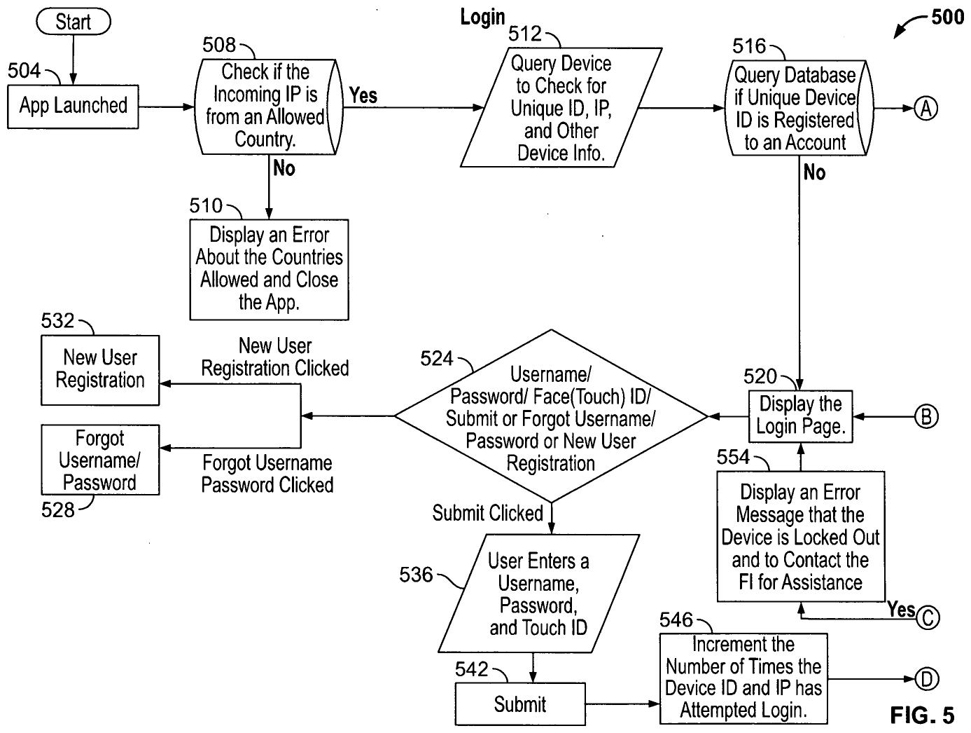

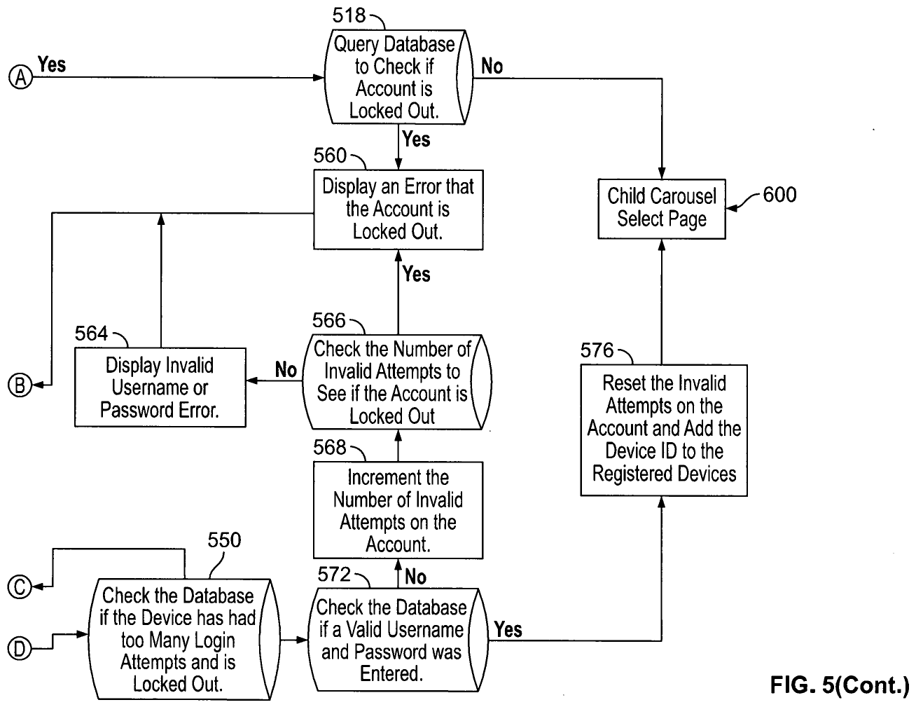

Referring now to FIG. 5, there is seen a block flow diagram, generally illustrated as 500, for login into a computer system for commencing an embodiment of the present invention. Block 504 represents a request or the launching of an application, such as when children are given access to financial benefits by parents. The request is inputted into a computer, preferably a cell phone (e.g. smart or android phone such as mobile devices 24 and 28), where after the request is transmitted to server, such as server 32. The server 32 (as well as the computer or cell phone devices 24 and 28) has a storage medium possessing the software which allows children and parents to operate the tool for embodiments of the invention.

After the application is launched or commenced, a check (see block 508) is made to determine if the internet protocol (IP) is from a country, person, or entity that has been given permission (or is licensed) to operate embodiments of the invention. If the country, person, or entity has not been given permission, an error (see block 510) is displayed, and the application is closed automatically. If the sent IP is from an allowed country, person, or entity, a determination (e.g., by the stored software or any other means) is subsequently made of the tool, device or computer for a unique ID (unique for tool, device or computer), IP (or any other additional tool, device or computer information), as reflected by block 512.

If unique ID or IP or other information has been discovered, then a determination is made (see block 516) as to whether the unique information (e.g., unique ID for device or computer) is registered to an account. If the information is registered, a database, which may be located at any suitable location (such as within the tool, cell phone or computer), is searched to determine if the user's account is locked out (see block 518). If the account is not locked out and is free to operate, then a child carousel (or child menue) program or database is engaged (see block 600).

If there is no registration to an account, then a login page (see block 520) is displayed. On the login page, the user enters and submits (as reflected in block 524) the following: username, password, face (touch) ID, submit or forgot username/password, or new user registration is requested. If the user password and/or username was forgotten, a new one may be created (block 528). Similarly, a new user registration may be entered (block 532).

After the username, password, and touch ID are selected and entered (see block 536), they are submitted, as indicated in block 542. Subsequently, an incremental step is performed (see block 546) to determine the number of times the login of device ID and IP has been attempted. The database within the tool, cell phone or computer is then searched to determine if too many login attempts have been made (which causes a lock out and prevents the procedure or method from progressing) as shown by block 550.

If too many logins have been attempted, an error sign is displayed (block 554), with instructions to contact the financial institution (FI) where funds are located for the child, if and when the child performs all of the necessary tasks in order to be awarded rights to funds. The FI may be contacted by any suitable means, such as by a message sent from the computer (or smartphone or android) or by telephone, or by any other suitable communication device. The FI may take any suitable steps after being contacted, such as contacting parents of the child, or contacting the designated individual registered with the FI.

If the computer (e.g., smart phone) determines that too many logins have not been attempted, the database is subsequently checked to determine if a valid username and password were originally entered (block 572). If a valid username and/or password was not entered, an incremental step is performed (see block 568), incrementing the number of invalid attempts on the account has been attempted. Subsequently, the number of invalid attempts is checked or determined to discover if the account is locked out (block 566). If the account is locked out, then an error is displayed, reflecting that the account is indeed locked out (see block 560). If the account is not locked out, an invalid username and/or password error is displayed (see block 564). If the computer determines that a valid username and/or password was entered, then the tool or computer resets the number of invalid attempts on the account, and then, as shown in block 576, the device ID is added to the registered devices, followed by the child carousel program or database being engaged (block 600).

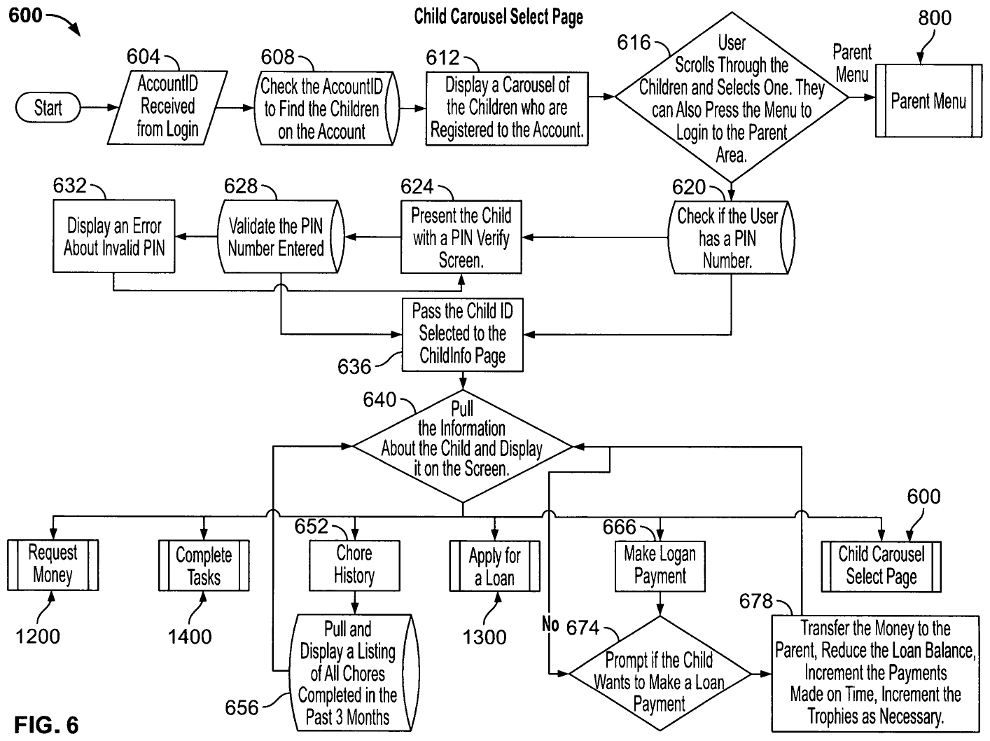

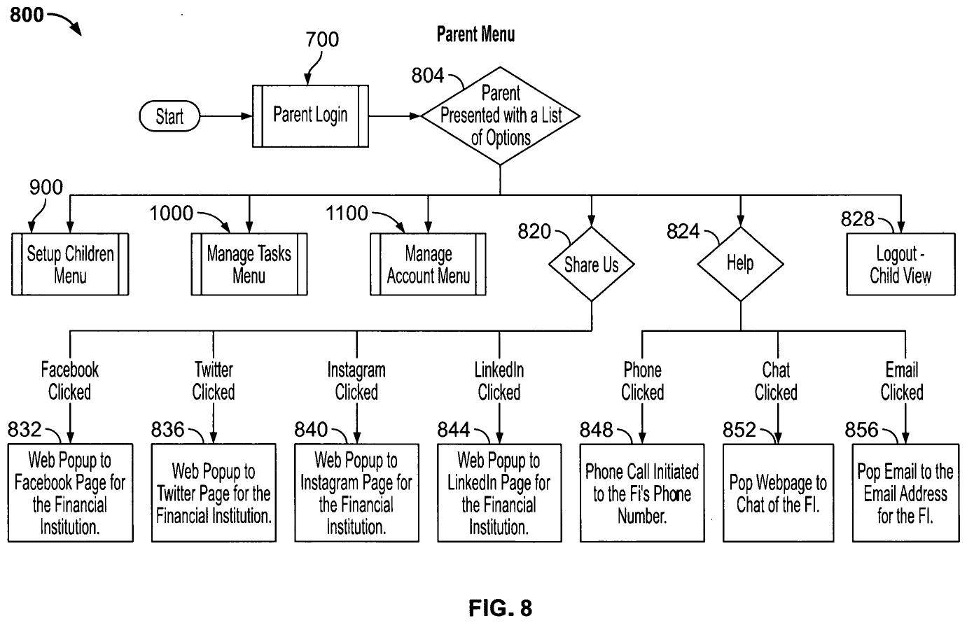

Referring now to FIG. 6, there is seen the block flow diagram for the child carousel program 600 of the present invention. An account ID (block 604) is received from the login illustrated in FIG. 5. After the account ID is received, the software determines if the account ID is registered as a permitted user, i.e., the software searches to find a child or children for the account (block 608). The carousel may be any suitable means for presenting identification of a child or children that are authorized users, such as display icon(s) (e.g., a word or graphic symbol whose form suggest meaning) or image(s) (see block 612 representing a displayed carousel of a child or children who are registered users to the account). After the carousel is displayed, the user or operator scrolls (as illustrated by block 616) through the children who are registered users, and subsequently selects the child or children who will be using the literacy tool. At this juncture, the user or operator may select the menu (parent menu represented by block 800, see FIG. 8)) for login into the parent section or part of the literacy tool.

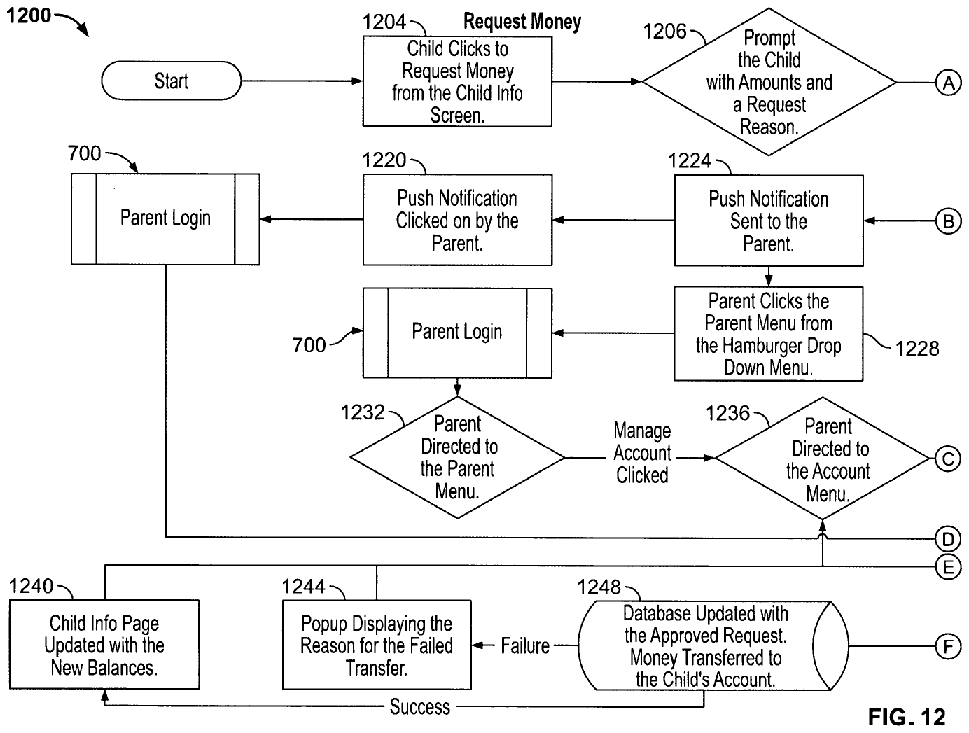

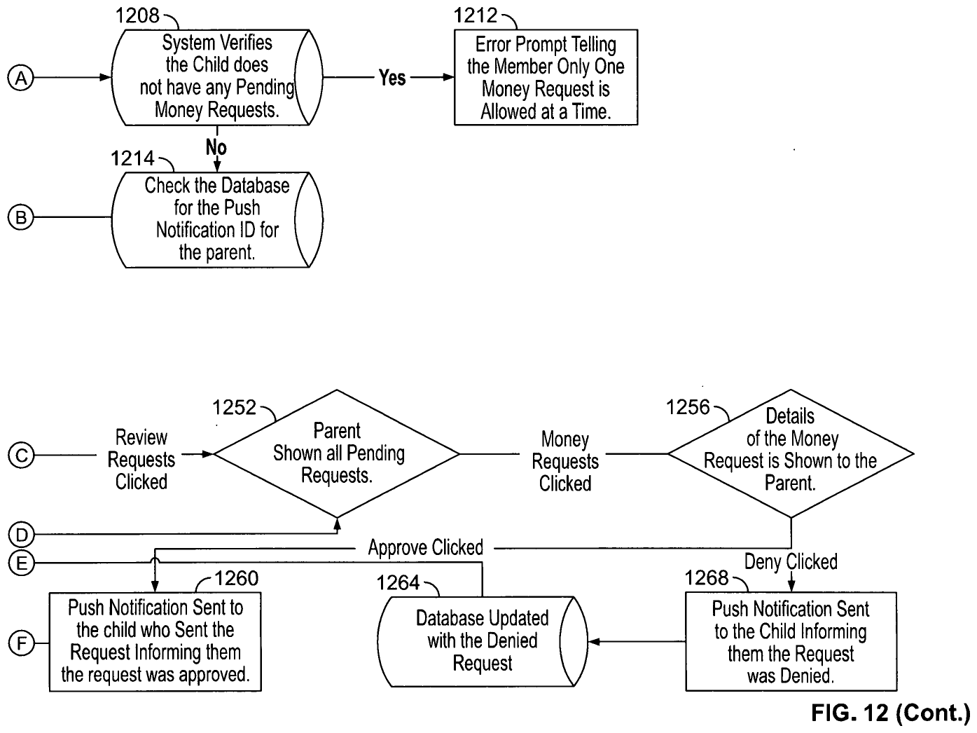

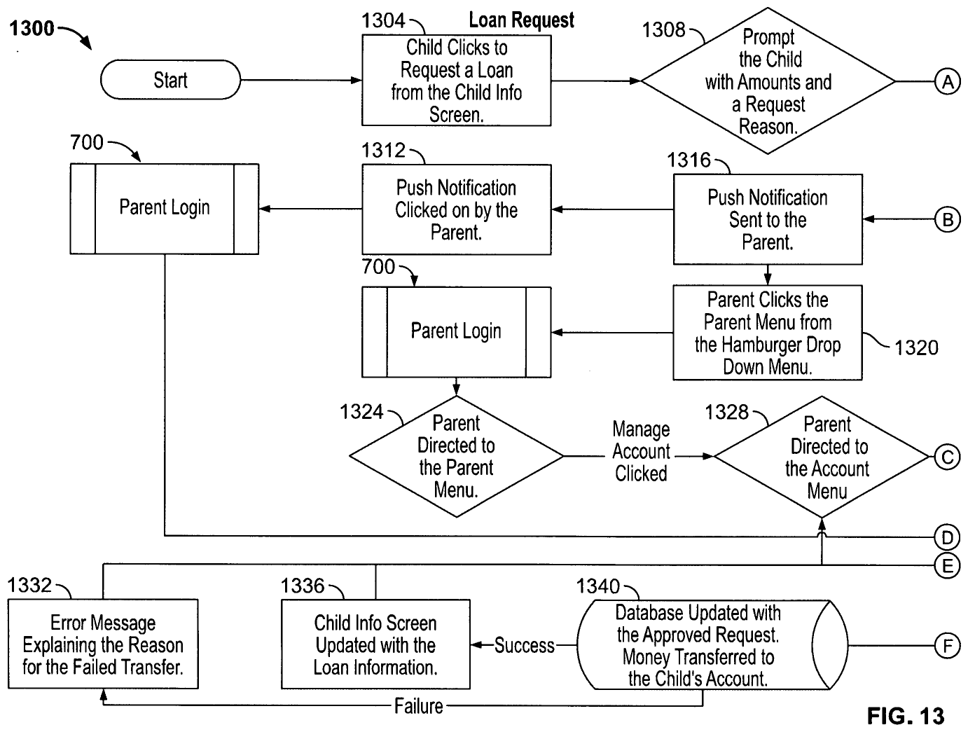

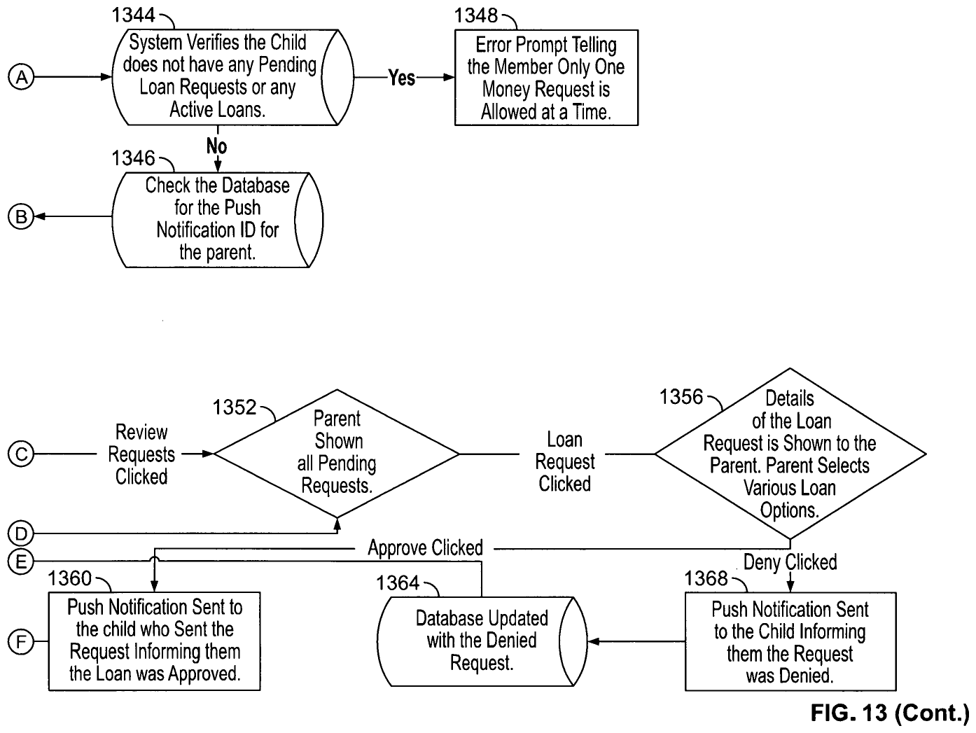

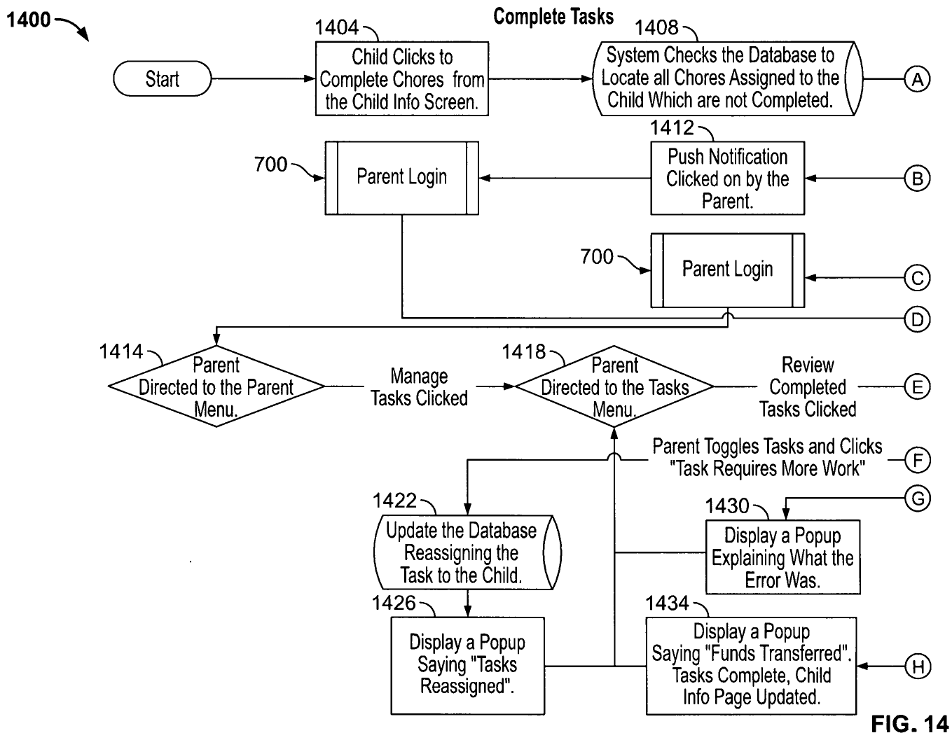

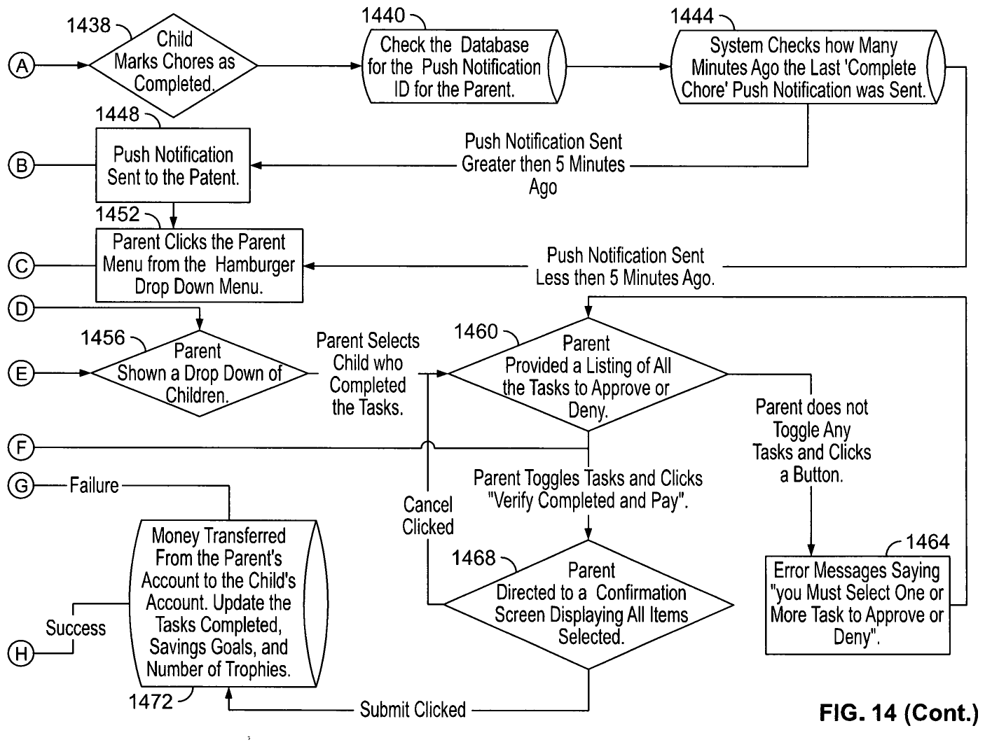

After the child or children are selected, as represented by block 616, a verification of the child's or children's identity is preferably made. The software determines if the selected child or children has/have a pin number (see block 620). A verification screen (block 624) is presented to the child or children for verifying the pin number. Validation of the pin number is then executed or entered on the verification screen (block 628). If validation can not be made, an error is displayed (block 632). If validation is accepted (block 628), then the selected child ID is transmitted or passed to a child-information page (block 636), where the information about or for the child or children may be pulled and displayed on a screen (block 640). The information displayed on screen includes: (1) option for child/children to request money (block 1200, see FIG. 12); (2) option for child/children to enter and update tasks which were completed (block 1400, see FIG. 14); (3) option to see chore history (i.e., history of all completed chores, block 652), such as displaying a list of all chores which were completed in the past (e.g. 3 months, see block 656); (4) option for child/children to apply for a loan (block 1300, see FIG. 13); (5) option for child/children to login (block 666) to make a payment, such as making a payment on a loan (block 674); and option to return to child carousel select page (block 600), i.e., child information screen. If a child or children wish to make a payment as represented by block 674, the child or children may elect to transfer money to the parent, or reduce the loan balance, or increment the payments made on time, or increment any rewards or trophies as necessary (see block 678).

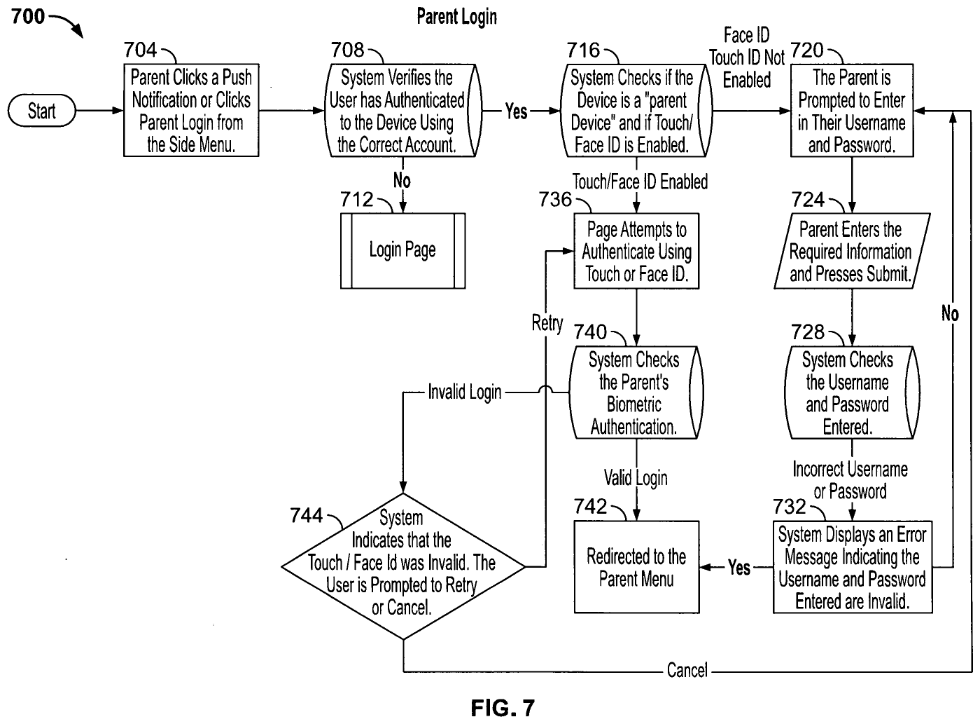

Referring now to FIG. 7, there is seen the block flow diagram for the parent login part for the literacy tool of the present invention. The parent commences to participate in the literacy tool by login with a computer, such as with one of the end user devices 20 (i.e., android device 28). If android device 28 is utilized by the parent, device 28 displays a screen upon which the parent may push or click a notification, or click “parent login” on a displayed login menu (block 704) on the screen. After login, the system for the literacy tool verifies and determines if the parent is authenticated to the android device 28 (and is authorized to use the literacy tool system) using the correct account (or pass word), as represented by block 708. If authentication fails, the login page returns and is displayed on the android device 28 (see block 712). If the authentication is successful, the literacy tool system determines if the android device 28 is a “parent device” (i.e., a computer which the parent is allowed to use for the literacy tool system) and if a touch/face ID is enabled (e.g. reflected by an ID or facial recognition icon or image displayed on the screen of the android device 28) for execution or engagement by the parent. The touch/face ID may be a pictogram displayed on the screen of the android device 28 and may be a representation of a software function or tool (or data file accessible within the literacy tool system).

If the touch/face ID is enabled, the parent touches the displayed touch/face ID, or the android device 28 may possess a facial ID recognition system for recognizing the face (or fingerprint) of the parent, for formally authenticating the parent and allowing the parent to proceed with literacy tool system (block 736). In a preferred embodiment of the invention, because the literacy tool system involves the use of sensitive and confidential information involving money or other types of rewards (or trophies), the android device 28 may possess biometric data which is unique to the parent. In such cases, the software and literacy tool system employs application of statistical analysis to parent-biological data to further authenticate the parent's authority to proceed with the literacy tool system (block 740). A failed biometric authentication produces in an invalid login, resulting in the literacy tool system indicating that the touch/face ID and/or the biometric application was invalid (block 744). The user or parent is then prompted to either retry or cancel the requested authentication. After all forms of authentication have been completed, a valid login occurs (block 742) and the software and literacy tool system displays on a screen of the android device 28, the parent menu 800, see FIG. 8.

If the software/literacy tool system determines that the touch/face ID is not enabled (see block 716), then the parent is prompted to enter in his/her username and password (block 720). After the parent enters the requested and required information, the parent submits the information into the software/literacy tool system (block 724) which subsequently checks the username and password (block 728). If the username and/or password are/is incorrect, the tool system displays an error message (block 732), indicating that the username and/or password are/is invalid. If no invalid entry is displayed, a valid login has occurred, then the parent is directed to the parent menu 800, see FIG. 8.

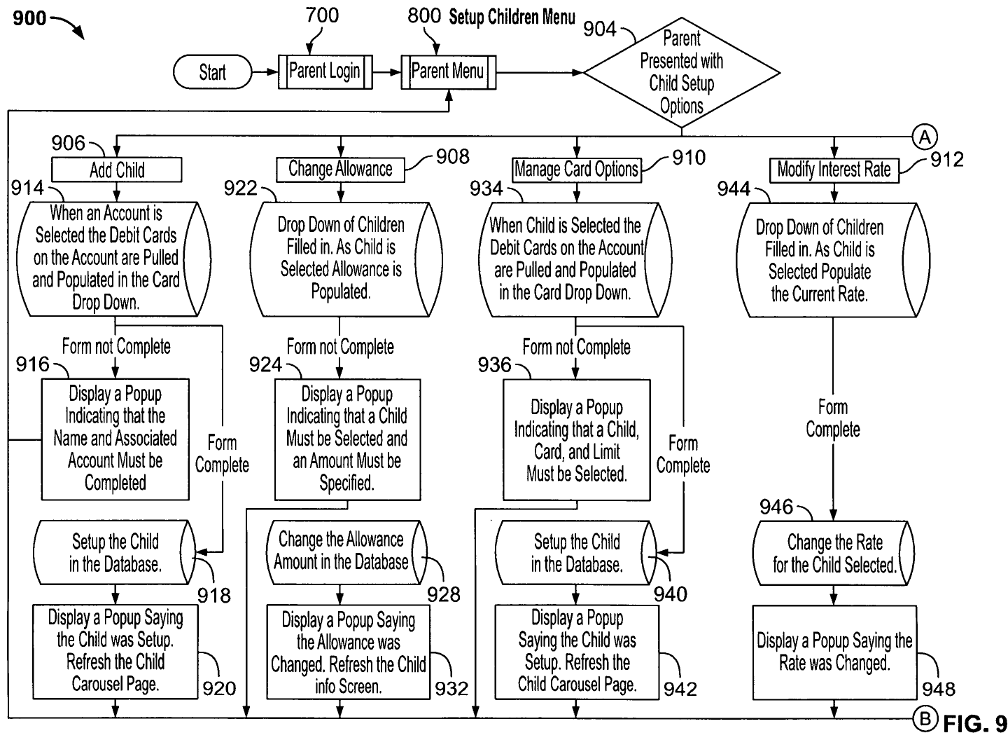

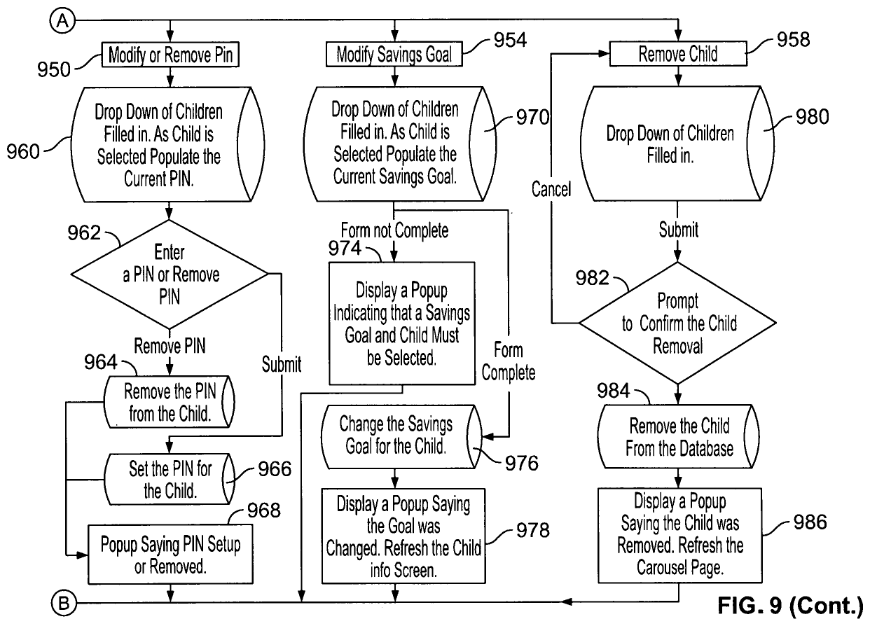

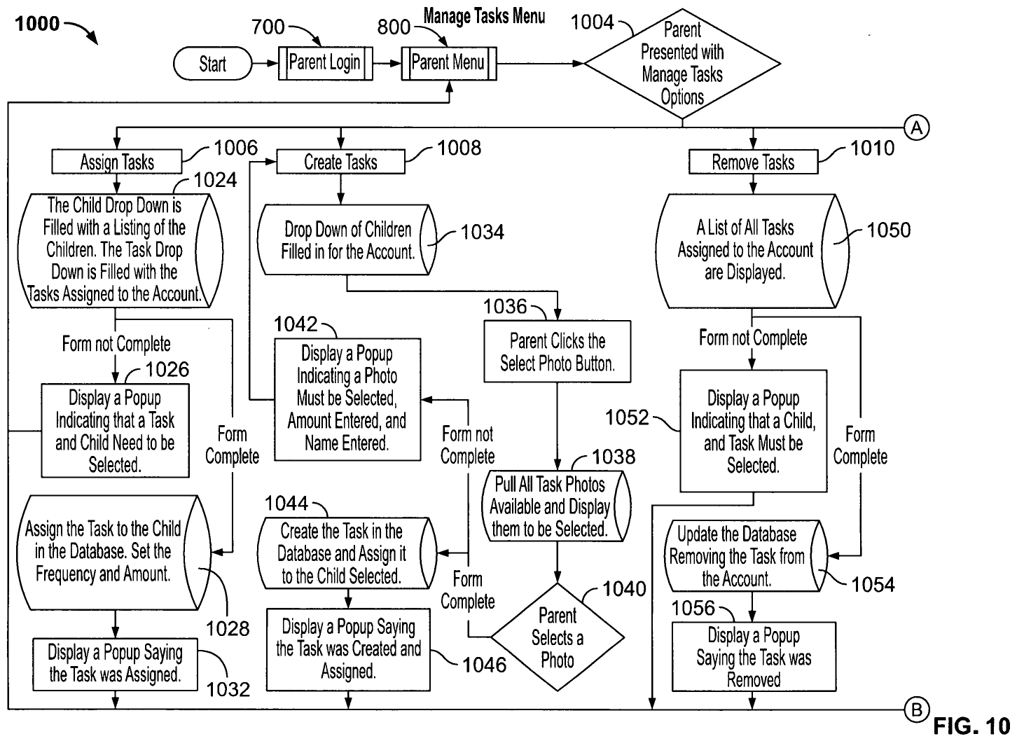

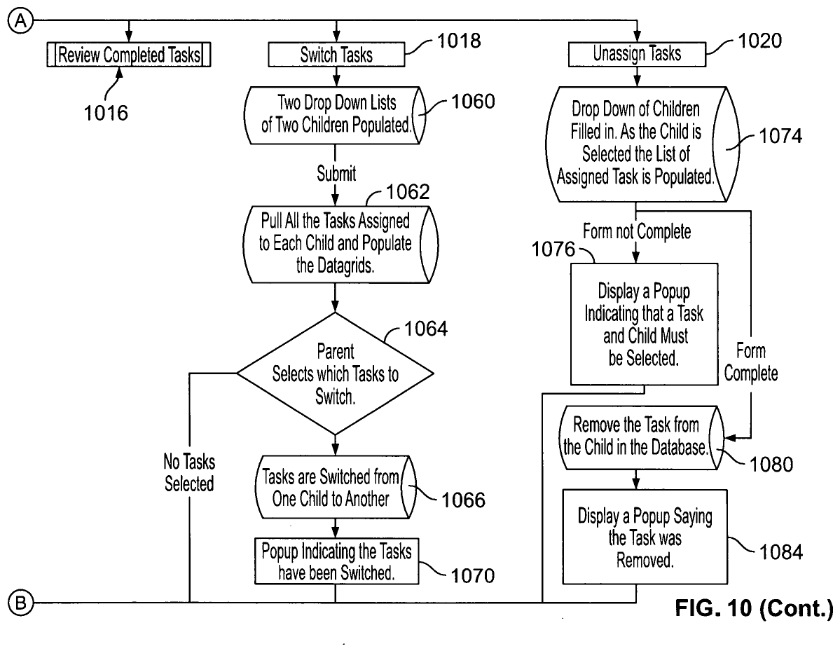

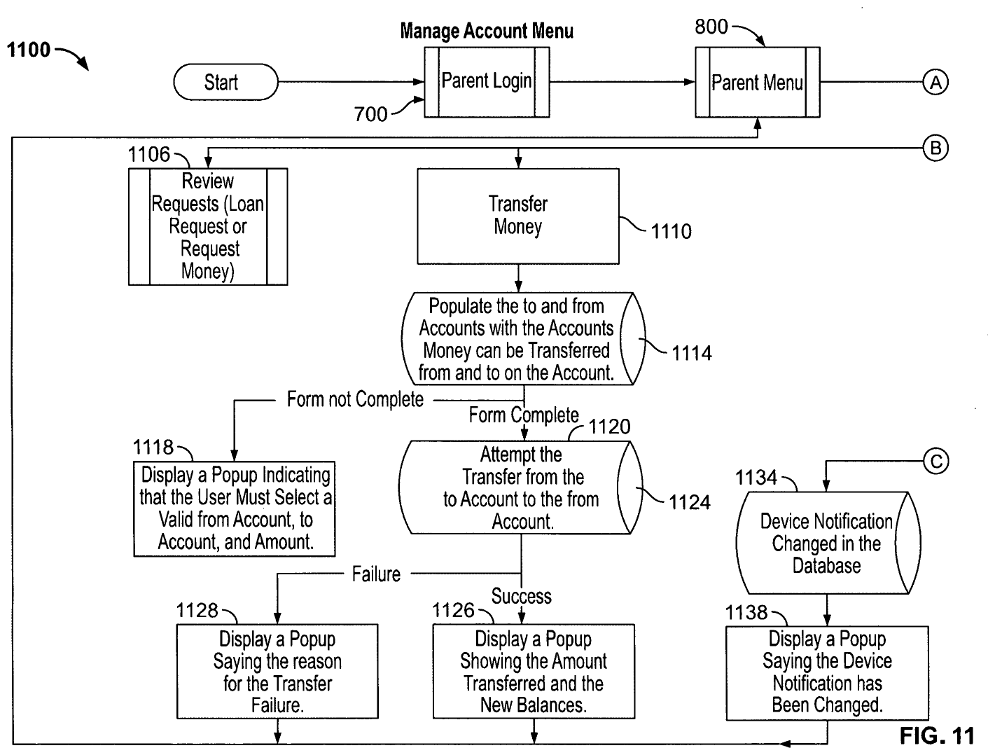

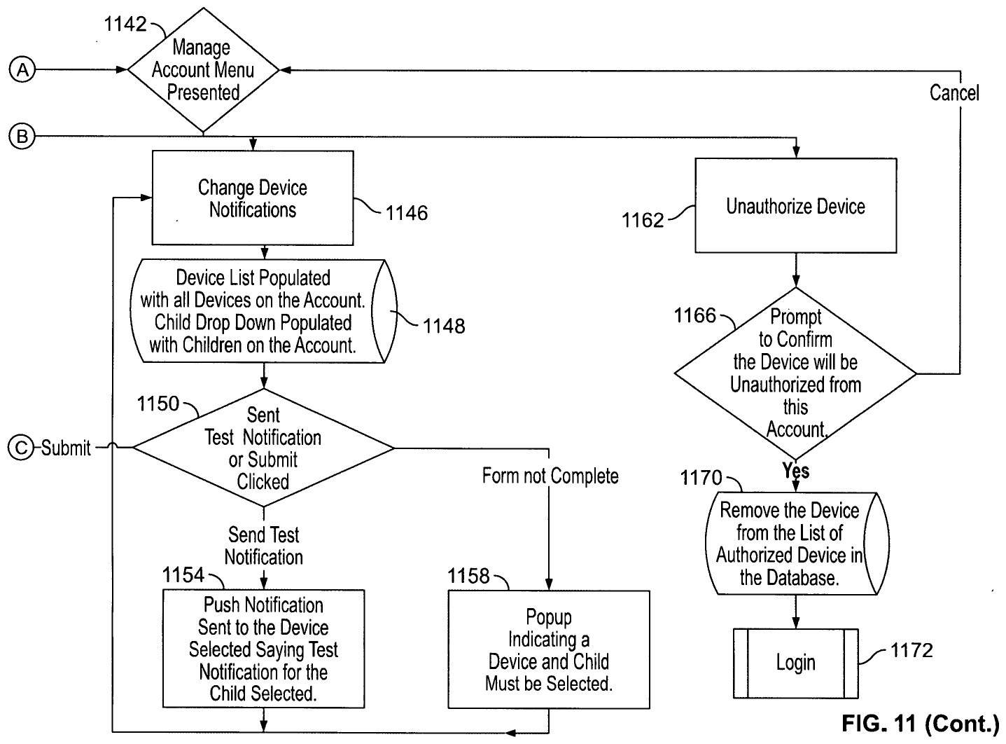

Referring now to FIG. 8, there is seen the block flow diagram for the parent menu 800 for the literacy tool of the present invention. After the parent logins into the software/literacy tool system (block 700), the parent is presented with a list of options (block 804); namely: (1) setup children menu, generally illustrated as 900 (see FIG. 9); (2) manage tasks menu, generally illustrated as 1000 (see FIG. 10); (3) manage account menu, generally illustrated as 1100 (see FIG. 11); (4) share us (block 820); (5) help (block 824); and (6) logout-child view (block 828) returns to the child menu so the child can utilize the solution.

The share us (block 820) option has displayed respective icons for facebook, twitter, instagram and linkedIn. Clicking on the facebook icon produces a web popup to the facebook page for the financial institution (block 832). Clicking on the twitter icon produces a web popup to the facebook page for the financial institution (block 836). Similarly, clicking on instagram and linkedIn icons, respectively, produces web popups to the instagram page (block 840) and linkedIn page (block 844), respectively, for the financial institution.

The help (block 824) option has displayed icons for phone, chat and Email. When the phone icon is clicked, a phone call is initiated to the financial institution's phone number (block 848). Clicking on the chat icon causes a webpage to popup for chatting, or communicating with the financial institution (block 852). Similarly, clicking on the Email icon causes an Email to popup having the Email address for the financial institution (block 856).

Referring now to FIG. 9, there is seen the block flow diagram for the setup children menu 900 for the literacy tool of the present invention. Menu 900 presents the parent with the following child setup options (block 904): (1) add child (block 906); (2) change allowance (block 908); (3) manage card options (block 910); (4) modify interest rate (block 912); (5) modify or remove Pin (block 950); (6) modify savings goal (block 954); and (7) remove child (block 958).

A parent wanting to add a child (block 906) to participate in the literacy tool of the present invention needs to register the child as an allowed participant. The parent selects an (already) existing account (block 914), which displays all valid debit cards registered on the account in the card drop down, as well as a form which is to be completed by the parent. After the parent fills out the form for registering a child, the child is then entered into the database (block 918) as an allowed participant for the literacy tool. If the form was inadvertently not fully (or improperly) completed by the parent, a popup is displayed (block 916) on the android device 28, indicating that the form has not been properly prepared (e.g., the name of child and associated account has not been completed). Once the child has been properly entered into the database of the literacy tool, a popup is displayed saying the child was setup and is an authorized participant for the financial literacy tool (block 920). The parent then refreshes the child carousel page 600 in order for the child's name to be listed in the carousel of children who are registered to the account (block 612).

A parent wishing to change an allowance for a child clicks on the change allowance icon, causing a drop down reflecting a list of the name of children (block 922). When the name of a child is selected and clicked-on, the allowance for the child is shown. A form is also displayed for the parent, allowing the parent to change the allowance. After the parent edits or fills out the form properly, the form is entered into the database, changing the amount of allowance for the child (block 928). If the form was inadvertently not fully (or improperly) completed by the parent, a popup is displayed (block 924) on the android device 28, indicating that the form has not been properly prepared (e.g., the name of child must be selected and the amount of the allowance must be specified). Once the desired allowance for the child has been properly entered into the database of the literacy tool, a popup is displayed saying the allowance was changed for the child (block 932). The parent then refreshes the child carousel page 600 (or child information screen) in order for the modified allowance for the child to be registered with the child's name.

Continuing to refer to FIG. 9, if a parent wishes to change any information related to a debit card (e.g., the amount money available for a child), the parent clicks on the manage card icon, causing a drop down screen being displayed, reflecting a list of the name of children (block 934). Stated alternatively, when a child is selected, debit cards on the child's account are pulled from the database, and populated on the card drop down screen. A form is also displayed for the parent, allowing the parent to change the amount of money available for a child from a debit card. After the parent properly edits the form, the form is entered into the database, changing the amount of money available for the child (block 940). Once the desired changes have been made to user-rights for the debit card, a popup is displayed saying the child was setup for the modified debit card changes (block 942). The parent then refreshes the child carousel page 600 (or child information screen) in order for the modified card changes for the child be registered with the child's name. If the form was inadvertently not fully (or improperly) completed by the parent, a popup is displayed (block 936) on the android device 28, indicating that the form has not been properly or completely prepared (e.g., the name of child and/or the limit and/or the particular card identification was missing).

A parent wishing to change any interest rate (block 912) clicks on the modify interest rate icon, causing a drop down screen being displayed, reflecting a list of the name of children and the current rate of interest for each child which is being assessed (block 934). A change of interest rate form is completed and entered, which changes the rate of interest charged for the child (block 946) as stored in the database. A popup is displayed, stating that the rate of interest for child has been changed (block 948).

To modify or remove a pin for a child, the parent clicks on the modify or remove pin icon, causing a drop down screen being displayed, reflecting a list of the names of children (block 960) and the respective Pin for each child. The parent may then proceed to modify the Pin (by entering a new Pin) or delete the Pin for a child (block 962). If the Pin is removed or deleted from a child (block 964), after an entry of removal has been made, a popup is displayed saying the Pin has been removed (block 968). If a modified or new Pin has been provided to a child, after submitting such entry, the new or modified Pin is set for the child (block 966) and a popup is displayed saying the new Pin has been entered or the new Pin has been modified (block 968).

To modify a savings goal (block 954) for a child, the parent clicks on the modify savings goal icon, causing a drop down reflecting a list of the name of children (block 970). When the name of a child is selected and clicked-on, the current savings goal(s) for the child is shown. A form is also displayed for the parent, allowing the parent to change the savings goal(s). After the parent edits or fills out the form properly, the form is entered into the database, changing the savings goal(s) for the child (block 976). If the form was inadvertently not fully (or improperly) completed by the parent, a popup is displayed (block 974) on the android device 28, indicating that the form has not been properly prepared (e.g., the name of child must be selected and the savings goal must be specified). Once the desired savings goal for the child has been properly entered into the database of the literacy tool, a popup is displayed saying the savings goal(s) was changed for the child (block 978). The parent then refreshes the child carousel page 600 (or child information screen) in order for the modified or new savings goal(s) for the child has been entered into the database.

To a remove a child (block 958) from participating in the literacy tool, the parent clicks on the remove child icon, causing a drop down reflecting a list of the name of children (block 980). When the name of a child is selected and clicked-on, the software and system prompts the parent to confirm that it is parent's desire to have the child removed from the literacy tool (block 982). If the parent cancels the removal step for a particular child, the software and system returns back to querying the parent if a child is to be removed (block 958). If the parent confirms that a child is to be removed from the database (block 984), a popup is displayed saying that the child has indeed been removed, and the carousel page 600 is accordingly subsequently refreshed (block 986).

Referring now to FIG. 10, there is seen the block flow diagram for the manage tasks menu 1000 for the literacy tool of the present invention. Menu 1000 presents the parent with the following manage-tasks options (block 1004): (1) assign tasks (block 1006); (2) create tasks (block 1008); (3) remove tasks (block 1010); (4) review completed tasks (block 1016); (5) switch tasks (block 1018); and (6) unassign tasks (block 1020).

A parent wishing to assign tasks for a child clicks on the assign tasks icon (block 1006), causing a drop down reflecting a list of the name of children and tasks assigned to each child (block 1024). The task drop down screen is filled with tasks assigned to the account of each child. A form is also displayed for the parent, allowing the parent to assign tasks. After the parent properly submits the form, reflecting the frequency and amount of tasks, the form is entered into the database (block 1028). If the form was inadvertently not fully (or improperly) completed by the parent, a popup is displayed (block 1026) on the android device 28, indicating that the form has not been properly prepared (e.g., the name of child must be selected and the tasks must be specified). Once the desired task for the child has been properly entered into the database of the literacy tool, a popup is displayed saying the tasks has been assigned for the child (block 1032). The child carousel page 600 (or child information screen) may be modified accordingly, reflecting the assigned tasks registered with the child's name.

A parent wishing to create tasks for a child, while using a photo of the child, clicks on the create tasks icon (block 1008), causing a drop down of the registered children (block 1034) for the account. The parent then clicks the select photo button (block 1036), which displays photos and tasks assigned to each photo, i.e., all available task photos are pulled from the database and displayed for selection by the parent (block 1038). As indicated by block 1040, the parent selects the desired photo of child and completes an associated form. If the form is properly completed, one or more tasks in the database are created for the child and assigned to the child through use of the photo of the child (block 1044). Subsequently, a popup is displayed stating that the task was created and assigned (block 1046). If the form was inadvertently not fully (or improperly) completed by the parent, a popup is displayed (block 1042) on the android device 28, indicating that the form has not been properly prepared (e.g., a photo of the child must be selected, the amount or number of tasks must be entered, or the name of child must be specified). Subsequently, the software and system returns the parent to the create tasks screen (block 1008) for starting over.

A parent wishing to remove one or more tasks for a child clicks on the remove tasks icon (block 1010), causing a drop down displaying a list of all tasks assigned to an account for a child (block 1050). The task drop down screen is filled with tasks assigned to the account of each child. A form is also displayed for the parent, allowing the parent to remove tasks. After the parent properly submits the form for removing one or more tasks for a child, the database is updated having task(s) removed (block 1054) and a popup is displayed stating that the task was removed (block 1056). If the form was inadvertently not fully (or improperly) completed by the parent, a popup is displayed (block 1052) on the android device 28, indicating that the form has not been properly prepared (e.g., the name of child must be selected and the tasks must be specified). The child carousel page 600 (or child information screen) may be modified accordingly, reflecting the previously assigned task(s) to the child as having been removed.

A parent desiring to switch one or more tasks from one or more children to one or more other children, the parent clicks on the switch tasks icon (block 1018), causing a drop down of a plurality of lists. In a preferred embodiment of the invention, and as best reflected in block 1060 shown in FIG. 10, the drop down is for two lists of two children (populated with tasks). The parent pulls all the tasks assigned to each child and which populate the datagrid (block 1062). The parent then selects which task(s) is/are to be switched (block 1064) and then appropriately clicks to switch tasks from one child to another child (block 1066). A popup is displayed stating that the task(s) was/were switched (block 1070).

A parent, wishing to unassign tasks for a child, clicks on the unassign tasks icon (block 1020), causing a drop down reflecting a list of the names of children authorized to participate in the literacy tool. When a particular name of a child is selected by the parent, the tasks assigned to the selected child is displayed or populated (block 1074). A form is displayed for the parent, allowing the parent to unassign tasks. After the parent properly fills out the form for unassigning tasks, the form is entered into the database (block 1080) for unassigning one or more tasks. If the form was inadvertently not fully (or improperly) completed by the parent, a popup is displayed (block 1076) on the android device 28, indicating that the form has not been properly prepared (e.g., the name of child must be selected and the tasks must be specified). Once the desired task for the child has been removed from the database of the literacy tool, a popup is displayed saying the task(s) was removed (block 1084). The child carousel page 600 (or child information screen) may be modified accordingly, reflecting the unassigned tasks that was previously registered with the child's name.

Referring now to FIG. 11, there is seen the block flow diagram for the manage account menu 1100 for the literacy tool of the present invention. Menu 1100, under manage account menu (block 1142), presents the parent with the following manage-account options: (1) review requests (e.g., loan request or request for money)(block 1006); (2) transfer money (block 1110); (3) change device (i.e., computer device) notifications (block 1146); and (4) unauthorize a computer device (i.e., inform the database that a particular computer device is no longer authorized to participate in the literacy tool (block 1162).

When a parent wishes to transfer money for the benefit of a child, say to a particular account (child account) at a financial institution, the parent clicks on the transfer money icon (block 1110), causing a drop down reflecting a list of accounts for each child registered and authorized to participate in the literacy tool. Block 1114 reflects a display enabling the parent to populate (or modify) the account receiving money from an account from which money may be transferred. A form is also displayed for the parent, allowing the parent to transfer money from one account to another account. After the parent completes (1120) the form, it is entered into the database (block 1124) for transferring money from one account to another. If the transfer of money was successful, a popup is displayed showing the amount of money transferred and the new balances for all relevant accounts (block 1126). If the form was inadvertently not fully (or improperly) completed by the parent, a popup is displayed (block 1128) on the android device 28, indicating the reason for the transfer failure.

A parent may change computer devices which are registered to participate in the literacy tool. When a parent clicks on a change-device notification icon (block 1146), a drop down appears, reflecting the identification of all computer devices which are authorized to be used in the literacy tool, along with the names of children who own or have the right to use each of the identified computer devices (block 1148). After the parent has made the desired changes pertaining to one or more of the computer devices (e.g., any child who has the right to use a computer device), a notification is sent to the computer device(s), and such change is reflected in the database for the literacy tool (block 1134), along with a popup being displayed stating that notification has been changed (block 1138). Before the notification is sent, the parent may wish to test the notification before finalizing it and submitting it into the database. To do so, the parent clicks “test notification” which transmits the notification to the child's computer device (block 1154) before it is entered into the database as a final occurrence. If an error occurs somewhere during the “change computer device” procedure, a popup occurs indicating such error (e.g., a computer device and/or child needs to be first selected before a change in computer devices can occur) (block 1158).

A parent may unauthorize a computer device for the literacy tool. When a parent clicks on an unauthorize device icon (block 1162), a drop down appears, prompting the parent to identify the computer device associated with an account, and to confirm that the identified device will be unauthorized from the particular account (block 1166). After the parent confirms the unauthorization, the computer device is removed from a list of authorized computer devices in the database (block 1170) and the software and system returns the parent to login (block 1172).

Referring now to FIG. 12, there is seen the block flow diagram for the request money 1200 for the literacy tool of the present invention. After the child displays the child information screen (block 1204) on his/her IOS device 24, the child clicks on a request money indicator shown on the child information screen. The child is then prompted to enter the amount of money requested, as well as the reason as to why the money is requested (block 1206). The software and system then determines if the child has any pending money requests (block 1208). If so, an error is displayed (block 1212) informing the child that only one money request is allowed at a time. If there are no pending money requests for the child, then the database is checked to determine if the parent knows of the money request from the child (block 1214: “check the database for the push notification ID for the parent”). The request for money (push) notification is sent to the parent's computer (device 28) (block 1224) for parent to address the child's request for money, such as by clicking on push notification (block 1220). Alternatively, the parent may click on a parent menu from a drop down menu, which enables the parents to eventually determine if there are any money requests pending from any children (block 1228).

Continuing to refer to FIG. 12, after the parent logins (block 700 in FIG. 12) on device 28 to participate in the literacy tool, the parent is directed to the parent menu (block 1232). When “manage account” is clicked, the parent is sent to the account menu (block 1236). On the account menu, after the parent clicks “review requests,” the parent is shown all pending money requests from a child or children (block 1252). To discern the details of the money requests, the parent clicks “money requests” (block 1256). If the parent approves the child's money requests, a notification (i.e., push notification) is sent to the child informing the child that the money requests has been approved (block 1260). The database is updated to reflect that the money request was approved and to transfer money to the child's account (block 1248). The child information page is then updated with the new balances (block 1240). If the update of the database failed, a popup is shown displaying the reason for the failed transfer of money (block 1244). If the parent denies the child's money requests, a notification (i.e., push notification) is sent to the child informing the child that the money requests has been denied (block 1268). The database is then updated to reflect that the money request(s) was denied (block 1264).

Referring now to FIG. 13, there is seen the block flow diagram for the loan request 1300 for the literacy tool of the present invention. Children participating in the literacy tool of the present invention have the opportunity to requests loans. On the child information screen, a child clicks on request loan icon (block 1304). After doing so, the child is prompted to enter the amount of loan requested along with the reason for the request (block 1308). After the child enters the amount requested, along with the reason, the software and system verifies that the child does not have any pending loan requests or any other active loans (block 1344). If the child does, and error is prompted telling the child that only a single (or limited) money requests is allowed at a time (block 1348). If there are no any pending loan request pending, the child checks the database for the push identification ID for the parent (block 1346). The push notification is sent to the parent (block 1316) to make the notification available to be clicked on by the parent (block 1312) after the parent logins (block 700). Alternatively, after the push notification is sent to the parent (block 1316), the parent may click the parent menu from a drop down menu (block 1320). After parent logins (block 700), the parent is directed to the parent menu (block 1324) where the “manage account” may be clicked, from where the parent is directed to the account menu (block 1328). When the account menu is displayed to the parent, the parent may click on “review requests,” enabling the parent to view all pending loan requests (block 1352). When the parent views all pending loan requests, a particular loan requests may be selected by the parent and when the particular loan requests is clicked-on, details of the loan request are shown to the parent, who then is able to select loan options (block 1356), i.e., either approve or disapprove the loan request. If the parent denies the loan requests, a notification is sent to the child informing him/her that the loan request was denied (block 1368). The database is then updated to reflect the denied loan request (block 1364). If the parent approves the loan requests, notification is sent to the child, who sent the loan request, informing him/her that the loan requests was approved (block 1360). The database is then updated with the approved request and money is transferred to the child's account (block 1340). The child information screen is also updated with the loan information. If the software and system fail to have money transferred to the child's account, an error message appears explaining the reason for the failed transfer (block 1332).

Referring now to FIG. 14, there is seen a block flow diagram 1400 of an embodiment of the present invention for determining if one (or more tasks) has been completed. When a child is presented with the child information screen, the child clicks on the icon “complete chores” (block 1404) in order to have the software and system check the database for locating all chores assigned to the child which have not been completed (block 1408). The child then has the opportunity to mark chores that have been completed, which were not previously indicated as not completed (block 1438). The database is then checked for the (push) notification ID for the parent (block 1440). The software and system then determine how many minutes ago the last “complete chore” notification was sent from the child (block 1444). If a notification was sent greater than 5 minutes ago, such notification is sent to the parent (block 1448). The notification may be clicked on by the parent (block 1412) and login is then available to the parent (block 700). Alternatively, the parent may click on the parent menu from the drop down menu for the parent (block 1452). If the notification was sent less than 5 minutes ago, then the parent has immediately available the parent menu from the drop down menu (block 1452) from which the parent may login (block 700). As reflected by block 1414, after login the parent is directed to the parent menu where the “manage tasks” icon may be clicked or entered, which sends the parent to the tasks menu (block 1418) where the parent may review child completed tasks. After the parent has reviewed the task(s) completed by the child, the parent is shown a drop down menu of children (block 1456) from which the parent may select the child who completed the assigned tasks. The parent is also provided a listing of all the tasks to approve or deny (block 1460). If parent inadvertently does not toggle any tasks and clicks a button, an error message is displayed saying “you must select one or more task to approve or deny” (block 1464). The parent toggles tasks and clicks “verify completed and pay” after which the parent is directed to a confirmation screen displaying all items selected (block 1468). After the parent clicks “submits,” money is transferred from the parent's account to the child's account, then the tasks completed is updated, along with savings goals and number of trophies (awards) (block 1472). If the money transfer was successful, a popup is displayed saying “funds transferred” tasks completed, and the child information page is updated (block 1434). If the money transfer was not successful, a popup is displayed, explaining what the error was (block 1430). If the parent toggles tasks and clicks “task requires more work,” the database is updated, reassigning the task to the child (block 1422) and causing a popup to be displayed saying “tasks reassigned” (block 1426).

Practice of embodiments of the present invention broadly provide tools. As previously indicated and described, one aspect of embodiments of the present invention provides a financial literacy tool which allows parents to give their children a debit card, while simultaneously being able to monitor and control their children's spending. The tool gives parents the ability to reward children for working hard and doing chores. Parents setup chores and tasks for children in the software and assign a dollar value to them. The children then perform the chores and the money is automatically transferred into the children's account at a financial institution. Children can also take out small loans from their parents, start a small business, purchase products online, or even earn rewards for making sound financial decisions. Thus, the tools of the present invention are beneficial to the parents, the children, as well as to any financial institution that assist the parents and children in the practice of embodiments of the present invention.

Use of the tool is beneficial to the parents in that their children learn the skills necessary to make sound financial decisions. Parents furnish their children access to money while the parents are simultaneously allowed to monitor and control the spending. Parents are able to reward children for their responsible actions instead of simply giving them a weekly allowance. Children learn about the benefits of hard work and are rewarded for it.

Practice of embodiments of the present invention are also beneficial to kids and teenagers, who enjoy competing against each other to try and get the most money and/or trophies. They learn about financial procedures, such as lending and making sound financial procedures.

Financial institution benefit from the use of the tools of the present invention. Financial institutions get to grow their member base while at the same time providing a valuable service to the community. This service will deepen the relationship financial institutions have with their members and open new areas for cross selling. Financial institutions can generate direct revenue with the tools of the present invention through a purchasing module.

Reference throughout the specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A tool for allowing a person to access financial services from a financial institution, comprising:
(a) a financial institution data processing system including at least one computer having stored financial service data pertaining to financial services for a first person, said financial service data selected from the group of data comprising data relating to at least one chore assigned to the first person by a second person, and data relating to a dollar amount of the assigned chore;
(b) a first computer for the first person and adapted for communicating with the financial institution data processing system, said first computer having a first display screen; and
(c) a second computer for the second person and adapted for communicating with the financial institution data process system to monitor the financial services, said second computer having a second display screen.

2. The tool of claim 1 wherein said group of data for the financial service data additionally comprises data related to a monetary allowance established by the second person for the first person, and data related to money to be transferred to the first person.

3. The tool of claim 1 additionally comprising a plurality of icons displayed on the first display screen, said icons being icons selected from the group of icons representing (a) requesting money; (b) task completed; (c) applying for a loan; and (b) history of chores.

4. The tool of claim 1 additionally comprising a notification from the financial institution displayed on the second display screen, said notification informing the second person that the first person conducted a transaction with the financial institution.

5. A non-transitory computer-readable medium comprising encoded instructions for execution by the one or more processors of a computer, the instructions when executed are operable to:
(a) receive a set of data from a financial institution, said set of data pertaining to at least one chore assigned to a first person by a second person; and
(b) determine, based on the received set of data, if the assigned chore has been completed by the first person.

6. The non-transitory computer-readable medium of claim 5 wherein said instructions when executed are additionally operable to receive a second set of data from a financial institution, said second set of data pertaining to a dollar amount for the assigned chore.

7. The non-transitory computer-readable medium of claim 5 wherein the instructions when executed are additionally operable to:
display a notification on a display screen for viewing by the second person whether the chore assigned to the first person has been completed.

8. A system for allowing a person to access financial services from a financial institution, comprising:
(a) a financial institution network comprising a data processing system including at least one computer having stored financial service data pertaining to financial services for a first person, said financial service data selected from the group of data comprising data relating to at least one chore assigned to the first person by a second person;
(b) a cloud services network;
(c) a first computer for the first person and adapted for communicating with the financial institution data processing system through the cloud services network, said first computer having a first display screen; and
(d) a second computer for the second person and adapted for communicating with the financial institution data process system through the cloud services network to monitor the financial services, said second computer having a second display screen.

9. The system of claim 8 wherein said cloud services network comprises an application server for communicating with the first and second computers, a notification hub communicating with the application server for allowing the user of the first and second computers to transmit notifications, an application API for specifying how the software components of the system operate, a database server communicating with the application API, and an administrator site web server communicating with the application API.

10. The system of claim 9 wherein said financial institution network comprises at least one credit union personal computer which communicates with the administrator site web server.

11. A method for accessing financial services from a financial institution, comprising:
(a) assigning at least one chore to a child;
(b) assigning a dollar value for the chore;
(c) storing the assigned chore and the dollar value in a financial institution data processing system;
(d) providing a computer for the child so the child can communicate with the financial institution data processing system;
(e) accessing by the child with the child computer the financial institution data processing system; and
(f) indicating by the child that the chore has been completed.

12. The method of claim 11 additionally comprising:
receiving money by the child after indicating that the chore has been completed.
